(19) United States
(12) Patent Application Publication
(10) Pub. No.: US 2023/0017922 A1
(43) Pub. Date: Jan. 19, 2023

(54) INCENTIVIZING UNMANNED AERIAL VEHICLE USE

(71) Applicant: SKYGRID, LLC, Austin, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 17/726,768

(22) Filed: Apr. 22, 2022

Related U.S. Application Data
(60) Provisional application No. 63/181,032, filed on Apr. 28, 2021.

(51) Int. Cl. G06Q 10/06

(52) U.S. Cl. CPC G06Q 10/063112

(57) ABSTRACT

Methods, systems, apparatuses, and computer program products for incentivizing UAV use are disclosed. In a particular embodiment, incentivizing UAV use includes UAV pilot recommendation by a computing system. In this embodiment, the computing system receives at least one parameter related to a prospective UAV mission and retrieves UAV flight records of a plurality of UAV pilots. According to this embodiment, the computing system recommends, based on the at least one parameter and the UAV flight records, at least one UAV pilot for the prospective UAV flight.

### CROSS-REFERENCE TO RELATED APPLICATIONS

This application is a non-provisional application for patent entitled to a filing date and claiming the benefit of earlier-filed U.S. Provisional Patent Application Ser. No. 63/181,032, filed Apr. 28, 2021, the contents of which are incorporated by reference herein in their entirety.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under (400) feet above ground level (AGL) in airspace where FAA air traffic services are not provided. However, a framework that extends beyond the (400) feet AGL limit is needed. For example, unmanned aircraft that would be used by package delivery services and air taxis may need to travel at altitudes above (400) feet. Such a framework requires technology that will allow the FAA to safely regulate unmanned aircraft.

### SUMMARY

Methods, systems, apparatuses, and computer program products for incentivizing UAV use are disclosed. In a particular embodiment, incentivizing UAV use includes UAV pilot recommendation by a computing system. In this embodiment, the computing system receives at least one parameter related to a prospective UAV mission and retrieves UAV flight records of a plurality of UAV pilots. According to this embodiment, the computing system recommends, based on the at least one parameter and the UAV flight records, at least one UAV pilot for the prospective UAV flight.

In a particular embodiment, incentivizing UAV use includes UAV pilot record recommendation by a computing system. In this embodiment, the computing system receives at least one parameter related to a UAV pilot and retrieves UAV pilot records of a plurality of UAV pilots. According to this embodiment, the computing system determines, based on the at least one parameter and the UAV pilot records, at least one record related to at least one UAV pilot to display.

In a particular embodiment, incentivizing UAV use includes UAV mission recommendation by a computing system. In this embodiment, the computing system receives at least one parameter related to a desired UAV mission and retrieves at least one prospective UAV mission record from a repository of prospective UAV mission records. According to this embodiment, the computing system determines, based on the at least one parameter and the at least one prospective UAV mission record, at least one prospective UAV mission to recommend for a UAV pilot.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system for incentivizing UAV use;

FIG. 2 is a block diagram illustrating another implementation of a system for incentivizing UAV use;

FIG. 3A a block diagram illustrating a particular implementation of the blockchain used by the systems of FIGS. 1-2 to record data associated with an unmanned aerial vehicle;

FIG. 3B is an additional view of the blockchain of FIG. 3A;

FIG. 3C is an additional view of the blockchain of FIG. 3A;

FIG. 4 is a block diagram illustrating a particular implementation of a UAV ecosystem for incentivizing UAV use;

FIG. 5 is a flowchart to illustrate an implementation of a method for UAV pilot recommendation;

FIG. 6 is a flowchart to illustrate another implementation of a method for UAV pilot recommendation;

FIG. 7 is a flowchart to illustrate another implementation of a method for UAV pilot recommendation;

FIG. 8 is a flowchart to illustrate an implementation of a method for UAV pilot record recommendation;

FIG. 9 is a flowchart to illustrate another implementation of a method for UAV pilot record recommendation; and

FIG. 10 is a flowchart to illustrate an implementation of a method for UAV mission recommendation.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

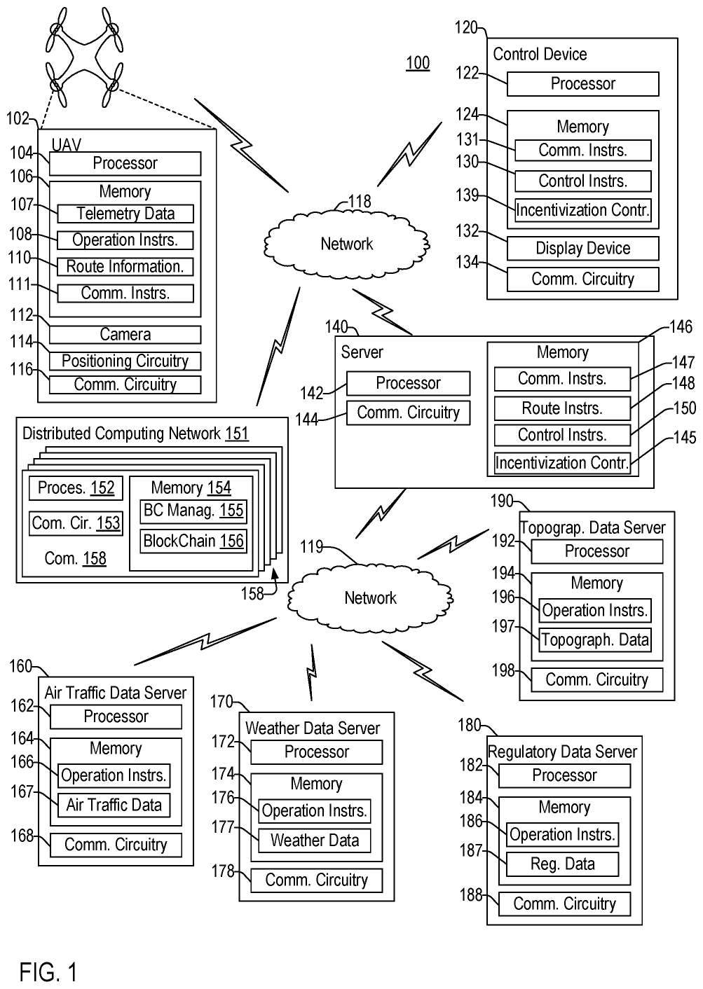

Exemplary methods, apparatuses, and computer program products for incentivizing UAV use in accordance with the present invention are described with reference to the accompanying drawings, beginning with FIG. 1. FIG. 1 sets forth a diagram of a system (100) configured for utilizing an unmanned aerial vehicle for emergency response according to embodiments of the present disclosure. The system (100) of FIG. 1 includes an unmanned aerial vehicle (UAV) (102), a control device (120), a server (140), a distributed computing network (151), an air traffic data server (160), a weather data server (170), a regulatory data server (180), and a topographic data server (190).

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones (drone taxi, flying taxi, or pilotless helicopter) carry human passengers.

For ease of illustration, the UAV (102) is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV (102) includes a processor (104) coupled to a memory (106), a camera (112), positioning circuitry (114), and communication circuitry (116). The communication circuitry (116) includes a transmitter and a receiver or a combination thereof (e.g., a transceiver). In a particular implementation, the communication circuitry (116) (or the processor (104) is configured to encrypt outgoing message(s) using a private key associated with the UAV (102) and to decrypt incoming message(s) using a public key of a device (e.g., the control device (120) or the server (140) that sent the incoming message(s). As will be explained further below, the outgoing and incoming messages may be transaction messages that include information associated with the UAV. Thus, in this implementation, communications between the UAV (102), the control device (120), and the server (140) are secure and trustworthy (e.g., authenticated).

The camera (112) is configured to capture image(s), video, or both, and can be used as part of a computer vision system. For example, the camera (112) may capture images or video and provide the video or images to a pilot of the UAV (102) to aid with navigation. Additionally, or alternatively, the camera (112) may be configured to capture images or video to be used by the processor (104) during performance of one or more operations, such as a landing operation, a takeoff operation, or object/collision avoidance, as non-limiting examples. Although a single camera (112) is shown in FIG. 1, in alternative implementations more and/or different sensors may be used (e.g., infrared, LIDAR, SONAR, etc.).

The positioning circuitry (114) is configured to determine a position of the UAV (102) before, during, and/or after flight. For example, the positioning circuitry (114) may include a global positioning system (GPS) interface or sensor that determines GPS coordinates of the UAV (102). The positioning circuitry (114) may also include gyroscope(s), accelerometer(s), pressure sensor(s), other sensors, or a combination thereof, that may be used to determine the position of the UAV (102).

The processor (104) is configured to execute instructions stored in and retrieved from the memory (106) to perform various operations. For example, the instructions include operation instructions (108) that include instructions or code that cause the UAV (102) to perform flight control operations. The flight control operations may include any operations associated with causing the UAV to fly from an origin to a destination. For example, the flight control operations may include operations to cause the UAV to fly along a designated route (e.g., based on route information (110), as further described herein), to perform operations based on control data received from one or more control devices, to take off, land, hover, change altitude, change pitch/yaw/roll angles, or any other flight-related operations. The UAV (102) may include one or more actuators, such as one or more flight control actuators, one or more thrust actuators, etc., and execution of the operation instructions (108) may cause the processor (104) to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information (110) may indicate a flight path for the UAV (102) to follow. For example, the route information (110) may specify a starting point (e.g., an origin) and an ending point (e.g., a destination) for the UAV (102). Additionally, the route information may also indicate a plurality of waypoints, zones, areas, regions between the starting point and the ending point.

The route information (110) may also indicate a corresponding set of control devices for various points, zones, regions, areas of the flight path. The indicated sets of control devices may be associated with a pilot (and optionally one or more backup pilots) assigned to have control over the UAV (102) while the UAV (102) is in each zone. The route information (110) may also indicate time periods during which the UAV is scheduled to be in each of the zones (and thus time periods assigned to each pilot or set of pilots).

In the example of FIG. 1, the memory (106) of the UAV (102) also includes communication instructions (111) that when executed by the processor (104) cause the processor (104) to transmit to the distributed computing network (151), transaction messages that include telemetry data (107). Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

The control device (120) includes a processor (122) coupled to a memory (124), a display device (132), and communication circuitry (134). The display device (132) may be a liquid crystal display (LCD) screen, a touch screen, another type of display device, or a combination thereof. The communication circuitry (134) includes a transmitter and a receiver or a combination thereof (e.g., a transceiver). In a particular implementation, the communication circuitry (134) (or the processor (122) is configured to encrypt outgoing message(s) using a private key associated with the control device (120) and to decrypt incoming message(s) using a public key of a device (e.g., the UAV (102) or the server (140) that sent the incoming message(s). Thus, in this implementation, communication between the UAV (102), the control device (120), and the server (140) are secure and trustworthy (e.g., authenticated).

The processor (122) is configured to execute instructions from the memory (124) to perform various operations. The instructions also include control instructions (130) that include instructions or code that cause the control device (120) to generate control data to transmit to the UAV (102) to enable the control device (120) to control one or more operations of the UAV (102) during a particular time period, as further described herein.

In the example of FIG. 1, the memory (124) of the control device (120) also includes communication instructions (131) that when executed by the processor (122) cause the processor (122) to transmit to the distributed computing network (151), transaction messages that include control instructions (130) that are directed to the UAV (102). In a particular embodiment, the transaction messages are also transmitted to the UAV and the UAV takes action (e.g., adjusting flight operations), based on the information (e.g., control data) in the message.

In addition, the memory (124) of the control device (120) also includes an incentivization controller (139). In a particular embodiment, the incentivization controller (139) includes instructions for UAV pilot recommendation that when executed by the processor (122) cause the processor (122) to carry out the operations of: receiving at least one parameter related to a prospective UAV mission; retrieving UAV flight records of a plurality of UAV pilots; and recommending, based on the at least one parameter and the UAV flight records, at least one UAV pilot for the prospective UAV flight.

In a particular embodiment, the incentivization controller (139) includes instructions for UAV pilot record recommendation that when executed by the processor (122) cause the processor (122) to carry out the operations of: receiving at least one parameter related to a UAV pilot; retrieving UAV pilot records of a plurality of UAV pilots; and determining, based on the at least one parameter and the UAV pilot records, at least one record related to at least one UAV pilot to display.

In a particular embodiment, the incentivization controller (139) includes instructions for UAV mission recommendation that when executed by the processor (122) cause the processor (122) to carry out the operations of: receiving at least one parameter related to a desired UAV mission; retrieving at least one prospective UAV mission record from a repository of prospective UAV mission records; and determining, based on the at least one parameter and the at least one prospective UAV mission record, at least one prospective UAV mission to recommend for a UAV pilot.

The server (140) includes a processor (142) coupled to a memory (146), and communication circuitry (144). The communication circuitry (144) includes a transmitter and a receiver or a combination thereof (e.g., a transceiver). In a particular implementation, the communication circuitry (144) (or the processor (142) is configured to encrypt outgoing message(s) using a private key associated with the server (140) and to decrypt incoming message(s) using a public key of a device (e.g., the UAV (102) or the control device (120) that sent the incoming message(s). As will be explained further below, the outgoing and incoming messages may be transaction messages that include information associated with the UAV. Thus, in this implementation, communication between the UAV (102), the control device (120), and the server (140) are secure and trustworthy (e.g., authenticated).

The processor (142) is configured to execute instructions from the memory (146) to perform various operations. The instructions include route instructions (148) comprising computer program instructions for aggregating data from disparate data servers, virtualizing the data in a map, generating a cost model for paths traversed in the map, and autonomously selecting the optimal route for the UAV based on the cost model. For example, the route instructions (148) are configured to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions (148) are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions (148) may also include instructions for storing the parameters of the selected optimal flight path as route information (110). For example, the route information may include waypoints marked by GPS coordinates, arrival times for waypoints, pilot assignments.

The instructions may also include control instructions (150) that include instructions or code that cause the server (140) to generate control data to transmit to the UAV (102) to enable the server (140) to control one or more operations of the UAV (102) during a particular time period, as further described herein.

In addition, the memory (146) of the server (140) also includes an incentivization controller (145). In a particular embodiment, the incentivization controller (145) includes instructions for UAV pilot recommendation that when executed by the processor (142) cause the processor (142) to carry out the operations of: receiving at least one parameter related to a prospective UAV mission; retrieving UAV flight records of a plurality of UAV pilots; and recommending, based on the at least one parameter and the UAV flight records, at least one UAV pilot for the prospective UAV flight.

In a particular embodiment, the incentivization controller (145) includes instructions for UAV pilot record recommendation that when executed by the processor (142) cause the processor (142) to carry out the operations of: receiving at least one parameter related to a UAV pilot; retrieving UAV pilot records of a plurality of UAV pilots; and determining, based on the at least one parameter and the UAV pilot records, at least one record related to at least one UAV pilot to display.

In a particular embodiment, the incentivization controller (145) includes instructions for UAV mission recommendation that when executed by the processor (142) cause the processor (142) to carry out the operations of: receiving at least one parameter related to a desired UAV mission; retrieving at least one prospective UAV mission record from a repository of prospective UAV mission records; and determining, based on the at least one parameter and the at least one prospective UAV mission record, at least one prospective UAV mission to recommend for a UAV pilot.

In the example of FIG. 1, the memory (146) of the server (140) also includes communication instructions (147) that when executed by the processor (142) cause the processor (142) to transmit to the distributed computing network (151), transaction messages that include control instructions (150) that are directed to the UAV (102).

The distributed computing network (151) of FIG. 1 includes a plurality of computers (157). An example computer (158) of the plurality of computers (157) is shown and includes a processor (152) coupled to a memory (154), and communication circuitry (153). The communication circuitry (153) includes a transmitter and a receiver or a combination thereof (e.g., a transceiver). In a particular implementation, the communication circuitry (153) (or the processor (152) is configured to encrypt outgoing message(s) using a private key associated with the computer (158) and to decrypt incoming message(s) using a public key of a device (e.g., the UAV (102), the control device (120), or the server (140) that sent the incoming message(s). As will be explained further below, the outgoing and incoming messages may be transaction messages that include information associated with the UAV. Thus, in this implementation, communication between the UAV (102), the control device (120), the server (140), and the distributed computing network (151) are secure and trustworthy (e.g., authenticated).

The processor (145) is configured to execute instructions from the memory (154) to perform various operations. The memory (154) includes a blockchain manager (155) that includes computer program instructions for utilizing an unmanned aerial vehicle for emergency response. Specifically, the blockchain manager (155) includes computer program instructions that when executed by the processor (152) cause the processor (152) to receive a transaction message associated with a UAV. For example, the blockchain manager may receive transaction messages from the UAV (102), the control device (120), or the server (140). The blockchain manager (155) also includes computer program instructions that when executed by the processor (152) cause the processor (152) to use the information within the transaction message to create a block of data; and store the created block of data in a blockchain data structure (156) associated with the UAV.

The blockchain manager may also include instructions for accessing information regarding an unmanned aerial vehicle (UAV). For example, the blockchain manager (155) also includes computer program instructions that when executed by the processor (152) cause the processor to receive from a device, a request for information regarding the UAV; in response to receiving the request, retrieve from a blockchain data structure associated with the UAV, data associated with the information requested; and based on the retrieved data, respond to the device.

The UAV (102), the control device (120), and server (140) are communicatively coupled via a network (118). For example, the network (118) may include a satellite network or another type of network that enables wireless communication between the UAV (102), the control device (120), the server (140), and the distributed computing network (151). In an alternative implementation, the control device (120) and the server (140) communicate with the UAV (102) via separate networks (e.g., separate short-range networks.

In some situations, minimal (or no) manual control of the UAV (102) may be performed, and the UAV (102) may travel from the origin to the destination without incident. However, in some situations, one or more pilots may control the UAV (102) during a time period, such as to perform object avoidance or to compensate for an improper UAV operation. In some situations, the UAV (102) may be temporarily stopped, such as during an emergency condition, for recharging, for refueling, to avoid adverse weather conditions, responsive to one or more status indicators from the UAV (102), etc. In some implementations, due to the unscheduled stop, the route information (110) may be updated (e.g., via a subsequent blockchain entry, as further described herein) by route instructions (148) executing on the UAV (102), the control device (120), or the server (140)). The updated route information may include updated waypoints, updated time periods, and updated pilot assignments.

In a particular implementation, the route information is exchanged using a blockchain data structure. The blockchain data structure may be shared in a distributed manner across a plurality of devices of the system (100), such as the UAV (102), the control device (120), the server (140), and any other control devices or UAVs in the system (100). In a particular implementation, each of the devices of the system (100) stores an instance of the blockchain data structure in a local memory of the respective device. In other implementations, each of the devices of the system (100) stores a portion of the shared blockchain data structure and each portion is replicated across multiple of the devices of the system (100) in a manner that maintains security of the shared blockchain data structure as a public (i.e., available to other devices) and incorruptible (or tamper evident) ledger. Alternatively, as in FIG. 1, the blockchain data structure (156) is stored in a distributed manner in the distributed computing network (151).

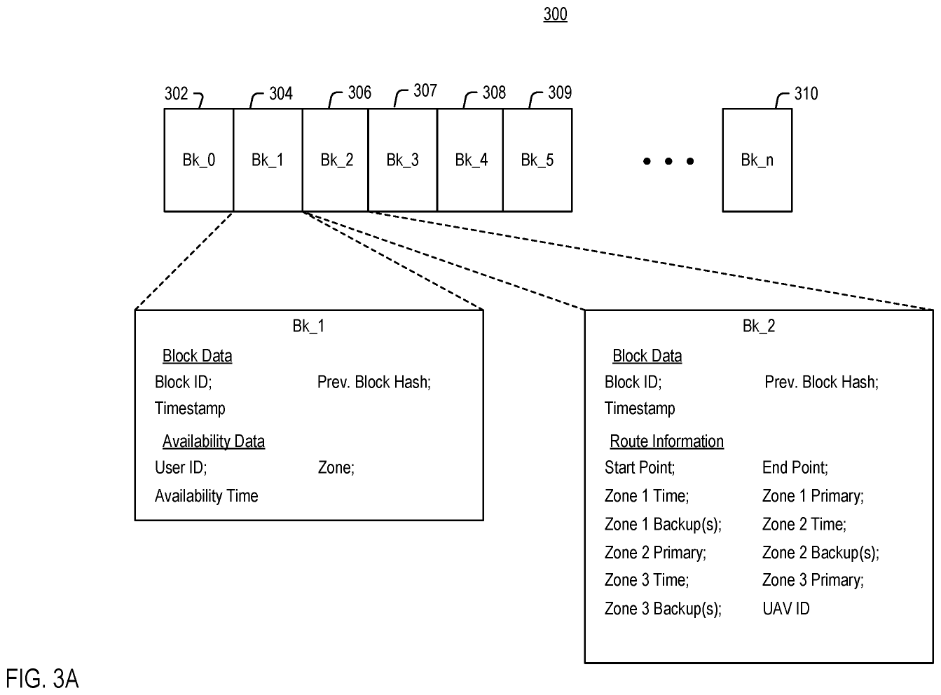

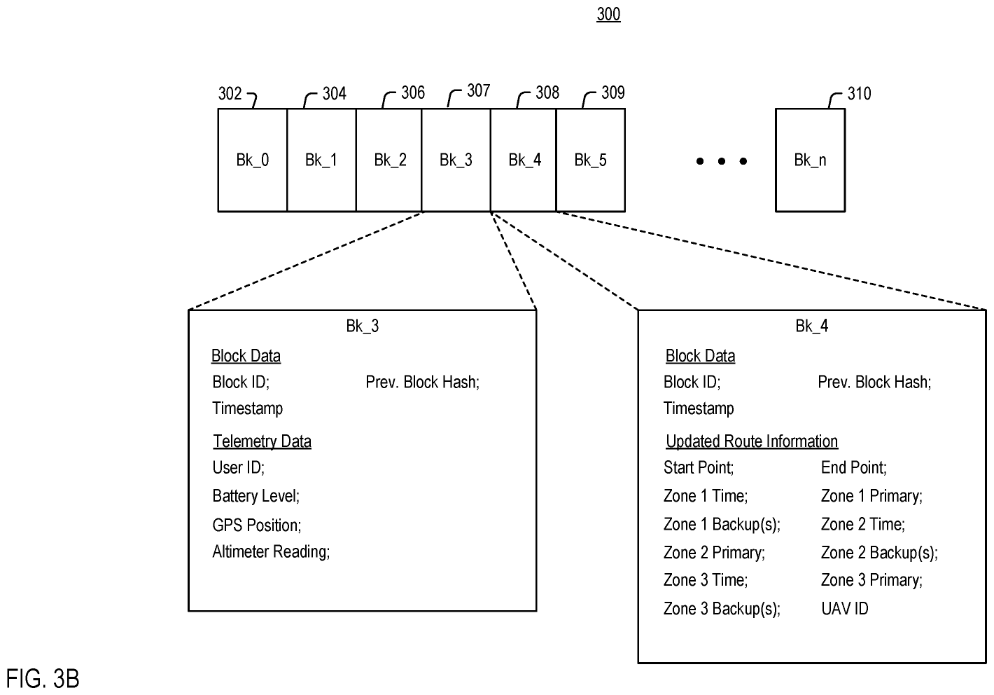

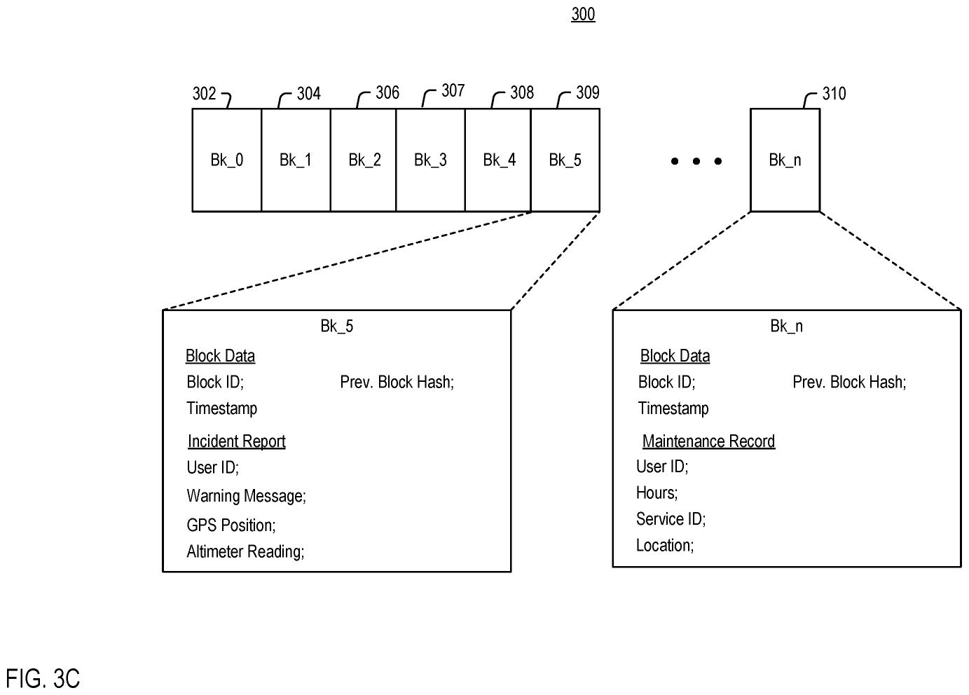

The blockchain data structure (156) may include, among other things, route information associated with the UAV (102), the telemetry data (107), the control instructions (130), and the route instructions (148). For example, the route information (110) may be used to generate blocks of the blockchain data structure (156). A sample blockchain data structure (300) is illustrated in FIGS. 3A-3C. Each block of the blockchain data structure (300) includes block data and other data, such as availability data, route data, telemetry data, service information, incident reports, etc.

The block data of each block includes information that identifies the block (e.g., a block ID) and enables the devices of the system (100) to confirm the integrity of the blockchain data structure (300). For example, the block data also includes a timestamp and a previous block hash. The timestamp indicates a time that the block was created. The block ID may include or correspond to a result of a hash function (e.g., a SHA(256) hash function, a RIPEMD hash function, etc.) based on the other information (e.g., the availability data or the route data) in the block and the previous block hash (e.g., the block ID of the previous block). For example, in FIG. 3A, the blockchain data structure (300) includes an initial block (Bk_0) (302) and several subsequent blocks, including a block Bk_1 (304), a block Bk_2 (306), a block BK_3 (307), a block BK_4 (308), a block BK_5 (309), and a block Bk_n (310). The initial block Bk_0 (302) includes an initial set of availability data or route data, a timestamp, and a hash value (e.g., a block ID) based on the initial set of availability data or route data. As shown in FIG. 1, the block Bk_1 (304) also may include a hash value based on the other data of the block Bk_1 (304) and the previous hash value from the initial block Bk_0 (302). Similarly, the block Bk_2 (306) other data and a hash value based on the other data of the block Bk_2 (306) and the previous hash value from the block Bk_1 (304). The block Bk_n (310) includes other data and a hash value based on the other data of the block Bk_n (310) and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system (100).

In addition to the block data, each block of the blockchain data structure (300) includes some information associated with a UAV (e.g., availability data, route information, telemetry data, incident reports, updated route information, maintenance records, etc.). For example, the block Bk_1 (304) includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 (306) includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 (307) includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network (151). In a particular embodiment, the UAV is configured to periodically broadcast to the network (118), a transaction message that includes the UAV's current telemetry data. The blockchain managers of the distributed computing network receive the transaction message containing the telemetry data and store the telemetry data within the blockchain data structure (156).

FIG. 3B also depicts the block BK_4 (308) as including updated route information having a start point, an endpoint, and a plurality of zone times and backups, along with a UAV ID. In a particular embodiment, the control device (120) or the server (140) may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network (118). The blockchain manager (155) in the distributed computing network (151), retrieves the transaction message from the network (118) and stores the information within the transaction message in the blockchain data structure (156).

FIG. 3C depicts the block BK_5 (309) as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n (310) that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server (140) includes software that is configured to receive telemetry information from an airborne UAV and track the UAV's progress and status. The server (140) is also configured to transmit in-flight commands to the UAV. Operation of the control device and the server may be carried out by some combination of a human operator and autonomous software (e.g., artificial intelligence (AI) software that is able to perform some or all of the operational functions of a typical human operator pilot).

In a particular embodiment, the route instructions (148) cause the server (140) to plan a flight path, generate route information, dynamically reroute the flight path and update the route information based on data aggregated from a plurality of data servers. For example, the server (140) may receive air traffic data (167) over the network (119) from the air traffic data server (160), weather data (177) from the weather data server (170), regulatory data (187) from the regulatory data server (180), and topographical data (197) from the topographic data server (190). It will be recognized by those of skill in the art that other data servers useful in-flight path planning of a UAV may also provide data to the server (140) over the network (101) or through direct communication with the server (140).

The air traffic data server (160) may include a processor (162), memory (164), and communication circuitry (168). The memory (164) of the air traffic data server (160) may include operating instructions (166) that when executed by the processor (162) cause the processor to provide the air traffic data (167) about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server (170) may include a processor (172), memory (174), and communication circuitry (178). The memory (174) of the weather data server (170) may include operating instructions (176) that when executed by the processor (172) cause the processor to provide the weather data (177) that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server (180) may include a processor (182), memory (184), and communication circuitry (188). The memory (184) of the weather data server (170) may include operating instructions (186) that when executed by the processor (182) cause the processor to provide the regulatory data (187) that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographic data server (190) may include a processor (192), memory (194), and communication circuitry (198). The memory (194) of the topographic data server (190) may include operating instructions (196) that when executed by the processor (192) cause the processor to provide the topographical data that indicates information about terrain, places, structures, transportation, boundaries, hydrography, orthoimagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server (140) may aggregate data from the data servers (160), (170), (180), (190) using application program interfaces (APIs), syndicated feeds and eXtensible Markup Language (XML), natural language processing, JavaScript Object Notation (JSON) servers, or combinations thereof. Updated data may be pushed to the server (140) or may be pulled on-demand by the server (140). Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, orthoimagery, land cover, and elevation. Readers of skill in the art will appreciate that various governmental and non-governmental entities may act as data servers and provide access to that data using APIs, JSON, XML, and other data formats.

Readers of skill in the art will realize that the server (140) can communicate with a UAV (102) using a variety of methods. For example, the UAV (102) may transmit and receive data using Cellular, 5G, Sub 1 GHz, SigFox, WiFi networks, or any other communication means that would occur to one of skill in the art.

The network (119) may comprise one or more Local Area Networks (LANs), Wide Area Networks (WANs), cellular networks, satellite networks, internets, intranets, or other networks and combinations thereof. The network (119) may comprise one or more wired connections, wireless connections, or combinations thereof.

The arrangement of servers and other devices making up the exemplary system illustrated in FIG. 1 are for explanation, not for limitation. Data processing systems useful according to various embodiments of the present disclosure may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

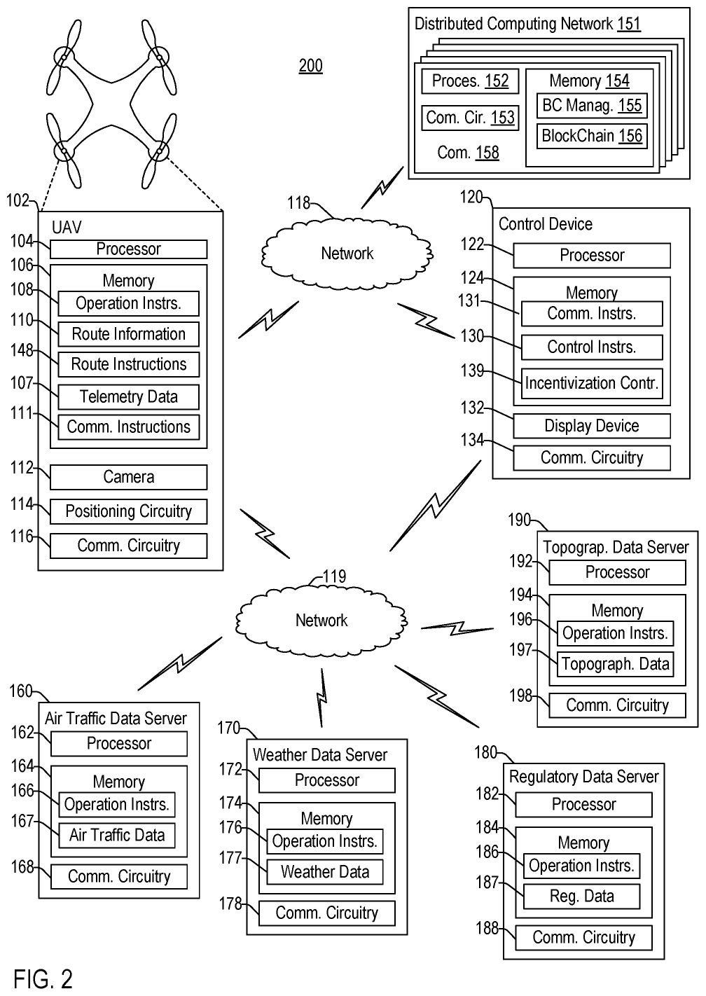

For further explanation, FIG. 2 sets forth a block diagram illustrating another implementation of a system (200) for utilizing an unmanned aerial vehicle for emergency response. Specifically, the system (200) of FIG. 2 shows an alternative configuration in which one or both of the UAV (102) and the server (140) may include route instructions (148) for generating route information. In this example, instead of relying on a server (140) to generate the route information, the UAV (102) and the control device (120) may retrieve and aggregate the information from the various data sources (e.g., the air traffic data server (160), the weather data server (170), the regulatory data server (180), and the topographic data server (190)). As explained in FIG. 1, the route instructions may be configured to use the aggregated information from the various source to plan and select a flight path for the UAV (102).

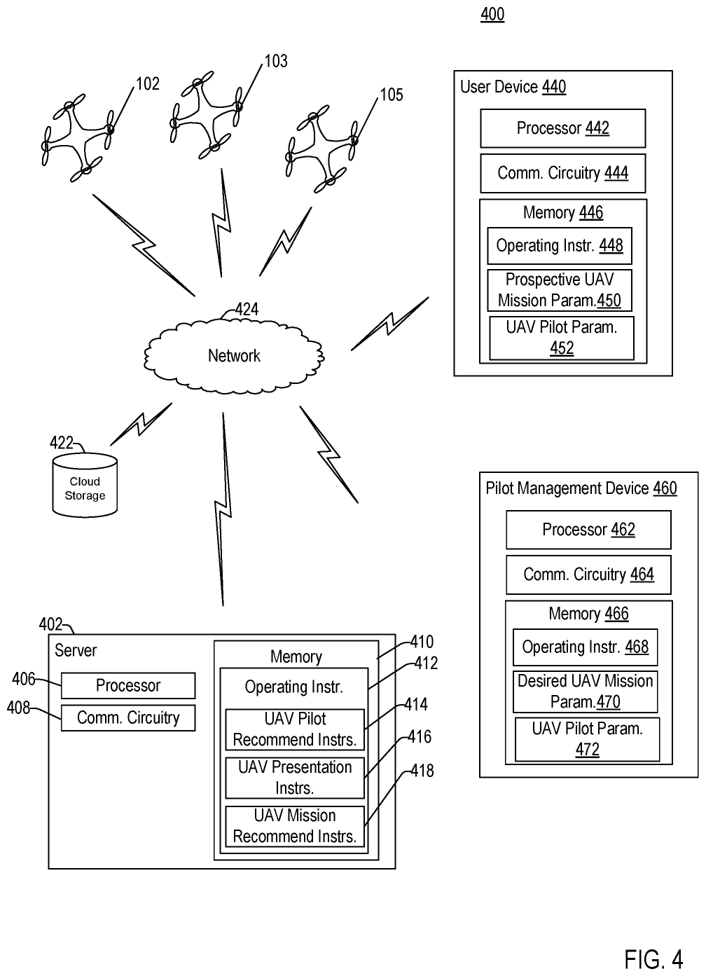

FIG. 4 is a block diagram illustrating a particular implementation of a system (400) for incentivizing UAV use. The system (400) includes the first UAV (102) of FIGS. 1-2, a second UAV (103), a third UAV (105), a server (402), a cloud storage device (422), a user device (440), and a pilot management device (460). Each of the devices are configured to be communicatively coupled to one another over at least one network (424).

The server (402) includes a processor (406) coupled to communication circuitry (408) and memory (410). The memory (410) includes operating instructions (412) which include UAV pilot recommendation instructions (414) configured to recommend a UAV pilot for a prospective UAV mission, UAV presentation instructions (416) configured to present UAV pilot records, and/or UAV mission recommendation instructions (418)) configured to recommend a prospective UAV mission for a UAV pilot as described hereafter. For example, the user device (440) may utilize an Application Program Interface (API) exposed by the server (402) to provide at least one prospective UAV mission parameter (450) to the server (402) or may send a request message (e.g., in the form of a transaction message) including at least one prospective UAV mission parameter (450). The server (402) may retrieve UAV flight records which may be stored locally, or in cloud storage device (422). The server (402) may then determine based on the at least one parameter received from the user device (440) and the retrieved UAV flight records at least one UAV pilot to recommend for the prospective UAV flight mission. In another example, the user device (440) or the UAV pilot management device (460) may utilize an Application Program Interface (API) exposed by the server (402) to provide at least one parameter related to a UAV pilot to the server (402) or may send a request message (e.g., in the form of a transaction message) including at least one parameter related to a UAV pilot. The server (402) may then retrieve UAV flight records which may be stored locally or remotely. The server may then determine based on the at least one parameter related to a UAV pilot at least one record related to at least one UAV pilot to display. In yet another example, a UAV pilot management device (460) may utilize an Application Program Interface (API) exposed by the server (402) to provide at least one parameter related to desired UAV missions to the server (402) or may send a request message (e.g., in the form of a transaction message) including at least one parameter related to a desired UAV mission. The server (402) may then retrieve prospective UAV mission records which may be stored locally or remotely. The server (402) may then determine based on the at least one prospective UAV mission parameter (450) at least one record related to at least one UAV pilot to display.

The server (402) may be a general computing device that is used by a network client to process requests related to UAV pilots, UAV missions, and UAV mission history. In some examples, the server (402) may be incorporated in server (140), or distributed computing network (151) of FIG. 1.

The user device (440) includes a processor (442) coupled to communication circuitry (444) and memory (446). The memory (446) includes operating instructions (448) which are configured to receive prospective UAV mission parameters (450) and provide the prospective UAV mission parameters (450) to a server, and receive UAV pilot parameters (452) related to a UAV pilot and provide the UAV pilot parameters (452) to a server. For example, a user may interact with a user interface of the user device (440) to input a parameter for a prospective UAV mission which may then be received by the user device (440) and provided to server (402) over network (424). In another example, a user may interact with the user interface of the user device to input a parameter related to a UAV pilot which may then be received by the user device (440) and provided to the server (402) over network (424).

The user device (440) can be any computing device configured to communicate with the server (402) to provide the prospective UAV mission parameters (450) to the server (402) and the UAV pilot parameters (452) to the server. In addition, the user device (440) may be configured to receive from the server (402) data related to at least one UAV pilot recommended by the server (402) based on the prospective UAV mission parameters (450) or at least one record of at least one UAV pilot based on the parameter related to a UAV pilot. Additionally, the user device (440) may be configured to display information about the at least one UAV pilot. In some examples, the user device may be a dedicated user device, or in other examples, the user device can be a general-purpose computer executing a program for recommending UAV pilots or an internet application.

The UAV pilot management device (460) includes a processor (462) coupled to communication circuitry (464) and memory (466). The memory (466) includes operating instructions (468) which are configured to receive desired UAV mission parameters (470) and provide the desired UAV mission parameters (470) to a server, and receive UAV pilot parameters (472) and provide the UAV pilot parameters (472) to a server. For example, a UAV pilot may interact with a user interface of the UAV pilot management device (460) to input a parameter for a desired UAV mission which may then be received by the UAV pilot management device (460) and provided to server (402) over network (424). In another example, a UAV pilot may interact with the user interface of the UAV pilot management device (460) to input a parameter related to a UAV pilot which may then be received by the UAV pilot management device (460) and provided to the server (402) over network (424).

The UAV pilot management device (460) can be any computing device configured to communicate with the server (402) to provide desired UAV mission parameters (470) to the server (402) and the UAV pilot parameters (472) to the server (402). In addition, the UAV pilot management device (460) may be configured to receive from the server (402) data related to at least one prospective UAV mission recommended by the server (402) based on the desired UAV mission parameters (470) or at least one record of at least one UAV pilot based on the UAV pilot parameters (472). Additionally, the UAV pilot management device (460) may be configured to display information about the recommended prospective UAV mission and the at least one UAV pilot. In some examples, the UAV pilot management device (460) device may be a dedicated user device, or in other examples, the user device can be a general-purpose computer executing a program for recommending UAV pilots or an internet application.

The UAV pilot recommendation instructions (414) are configured to recommend at least one UAV pilot for a prospective UAV mission based on parameters received over the network and UAV flight records of a plurality of UAV pilots. The UAV pilot recommendation instructions (414) may recommend a UAV pilot based on the received parameter matching at least one UAV flight record. UAV flight records may be stored, and data accumulated based on historical UAV flights including information such as, but not limited to, UAV pilot flight hours, UAV flight hours, UAV pilot geographic experience, UAV pilot rating, UAV rating, UAV mission type, UAV pilot experience rating, UAV type, trust rating, cumulative UAV missions, or UAV addons. The following table gives examples of each of these parameters.

| | |
|---|---|
| UAV pilot flight hours | A quantity of time that the UAV pilot has |
| | flown. May be broken down by individual |
| | UAVs if the UAV pilot has multiple UAVs. |
| UAV flight hours | A quantity of time that a UAV has flown |
| | regardless of UAV pilot. Indicates an overall |
| | usage of the UAV. |
| UAV pilot geographic | Geographic areas or physical locations where |
| experience | a UAV pilot has flown. For example, |
| | mountainous terrain, forests, cities, or |
| | particular locations such as Golden Gate |
| | Bridge or Statue of Liberty. |
| UAV pilot rating | A rating based on client reviews. |
| UAV rating | A rating based on the type of UAV being |
| | used. May be derived by independent third- |
| | party reviewers or other sources. |
| UAV mission type | A parameter indicating a type of UAV |
| | mission, such as inspection, mapping, |
| | photography, video, delivery, or other type of |
| | mission. |
| UAV pilot experience | A rating determined by the server based on |
| rating | the UAV flight records of the UAV pilot. |
| | May be based on a combination of UAV pilot |
| | flight hours, geographic experience, customer |
| | ratings, and other parameters. |
| UAV model | An indication of the UAV model. |
| UAV addons/features | An identification of features that are present |
| | or that may be added on to a UAV. For |
| | example, camera mounts, payload capacity, |
| | night flying, ground penetrating radar, |
| | mapping capabilities, range, flight time, or |
| | other relevant features. |

For example, a user may have a prospective mission that requires a UAV pilot having at least one hundred hours of commercial flight experience. The UAV pilot recommendation instructions (414) can cause the processor to find UAV pilots having at least the minimum number of commercial flight hours as indicated by the UAV flight records. In another example, a user may have a prospective mission that requires the UAV to have a stabilized camera mount, experience in mountainous terrain, and have flown for at least fifty hours. The UAV pilot recommendation instructions (414) may cause the processor to find UAV pilots meeting these criteria. Additionally, the criteria may be weighted to emphasize certain parameters. If multiple UAV pilots are found that meet the criteria, the UAV pilot recommendation instructions (414) can further cause a group of UAV pilots to be recommended or may rank the UAV pilots based on the quality of the match between the parameters and the UAV pilot flight history.

The UAV pilot recommendation instructions (414) may further be configured to receive, a selection of a UAV pilot to fly the prospective mission. For example, the server (402) may provide the user device (440) with a group of recommended UAV pilots. A user may then select one of the UAV pilots and the user device (440) can provide the selection to the server (402). In some examples, the UAV pilot recommendation instructions (414) may further be configured to notify the UAV pilot that they were selected. For example, server (402) may send a notification message to UAV pilot management device (460) to notify the UAV pilot they were selected for a mission.

The UAV presentation instructions (416) are configured to present UAV mission information based on at least one parameter related to a UAV pilot and UAV pilot records. The UAV presentation instructions (416) may determine at least one UAV pilot record related to at least one UAV pilot to display based on the received parameter matching at least one UAV pilot record. The UAV pilot records may be stored, and data accumulated based on historical UAV flight records or in some examples, they may be generated based on the historical UAV flight records. The UAV pilot records may include information such as, but not limited to, a UAV pilot name, a UAV pilot identification, a UAV pilot location, a UAV type, a UAV name, a UAV model, a UAV location, or a UAV pilot rating. The following table gives examples of each of these parameters.

| | |
|---|---|
| UAV pilot name | A name of the UAV pilot. |
| UAV pilot identification | An identifier other than a name. Can be a |
| | globally unique identifier or a nickname. |
| UAV pilot location | Geographic location of the UAV pilot. |
| UAV category | In indication of a category of UAV such as |
| | large/small, gas/electric, surveillance, |
| | security, etc. |
| UAV name | A name for the UAV. In some instance a |
| | UAV can be named. |
| UAV model | A parameter indicating a model of UAV. |
| UAV location | The physical location of the UAV. |
| UAV pilot rating | A rating based on client reviews. |

For example, a user or UAV pilot may want to view a record related to a particular UAV pilot. The user or UAV pilot can provide the UAV pilot name and the UAV presentation instructions can retrieve UAV pilot records of a plurality of UAV pilots and determine a UAV pilot record to display based on the UAV pilot name matching the UAV pilot name in a UAV pilot record. In another example, a user or UAV pilot can provide a UAV pilot location and the UAV presentation instructions can retrieve UAV pilot records and determine at least one UAV pilot record to display based on at least one UAV pilot having a location matching the UAV pilot location provided to the server.

In another example, the UAV presentation instructions can cause the processor to determine a UAV pilot experience rating based on the UAV flight records corresponding to the respective UAV pilot. For example, the UAV presentation instructions may calculate a UAV pilot experience rating based on a combination of UAV pilot flight hours, geographic experience, customer ratings, and other parameters. In another example, the UAV presentation instruction can cause the processor to award a badge to a UAV pilot. For example, experience badges can be awarded to UAV pilots that exceed set experience ratings, or a badge can be awarded for certain mission locations, mission types, number of missions, or other UAV flight histories.

The UAV pilot recommendation instructions (414) may further be configured to receive, a selection of UAV pilot to fly the prospective mission. For example, the server (402) may provide the user device (440) with a group of recommended UAV pilots. A user may then select one of the UAV pilots and the user device (440) can provide the selection to the server (402). In some examples, the UAV pilot recommendation instructions (414) may further be configured to notify the UAV pilot that they were selected. For example, server (402) may send a notification message to UAV pilot management device (460) to notify the UAV pilot they were selected for a mission.

The UAV presentation instructions (416) may further be configured to send a command to display a UAV pilot record of the at least one UAV pilot and the at least one badge of the respective UAV pilot. For example, the UAV pilot instructions may cause the processor to send a command to the user device (440) by way of network (424) to display the at least one UAV pilot record and the badge. In some examples, the UAV presentation instructions may cause the processor to send a group of UAV pilot records and associate badges to be display at the user device. For example, the user device may display the UAV pilot records and the respective badges in a ranked order. Thus, if a user were to cause UAV pilot parameters (472) to be sent to the server (402) indicating a selection of the Grand Canyon for a UAV pilot location, the server can return a plurality of UAV pilot records of UAV pilots having the Grand Canyon as their physical location. The user device may display the plurality of UAV pilot records in a ranked order according to their UAV pilot experience rating and display any badges that were awarded to the UAV pilots.

The UAV mission recommendation instructions (418) are configured to recommend a UAV mission to a UAV pilot based on at least one parameter related to a desired UAV mission and a prospective UAV mission record. The UAV mission recommendation instructions (418) may recommend at least one prospective UAV mission based on the received parameter matching at least one prospective UAV mission record. The prospective UAV mission records may be received over the network (424) from the user device (440) and may be stored. The prospective UAV mission records may include information such as, but not limited to a description of the mission, required equipment, required UAV pilot experience, and other parameters as desired by the user.

For example, a user can enter prospective UAV mission parameters (450) using a user interface of user device (440). The prospective UAV mission parameters (450) can then be provided to the server (402). A UAV pilot can enter desired UAV mission parameters (470) using a user interface of UAV pilot management device (460). The UAV pilot management device can provide the desired UAV mission parameters to server (402). The UAV mission recommendation instructions (418) can cause the processor to compare the desired UAV mission parameters (470) to the prospective UAV mission parameters (450) to determine a suitable mission for a UAV pilot.

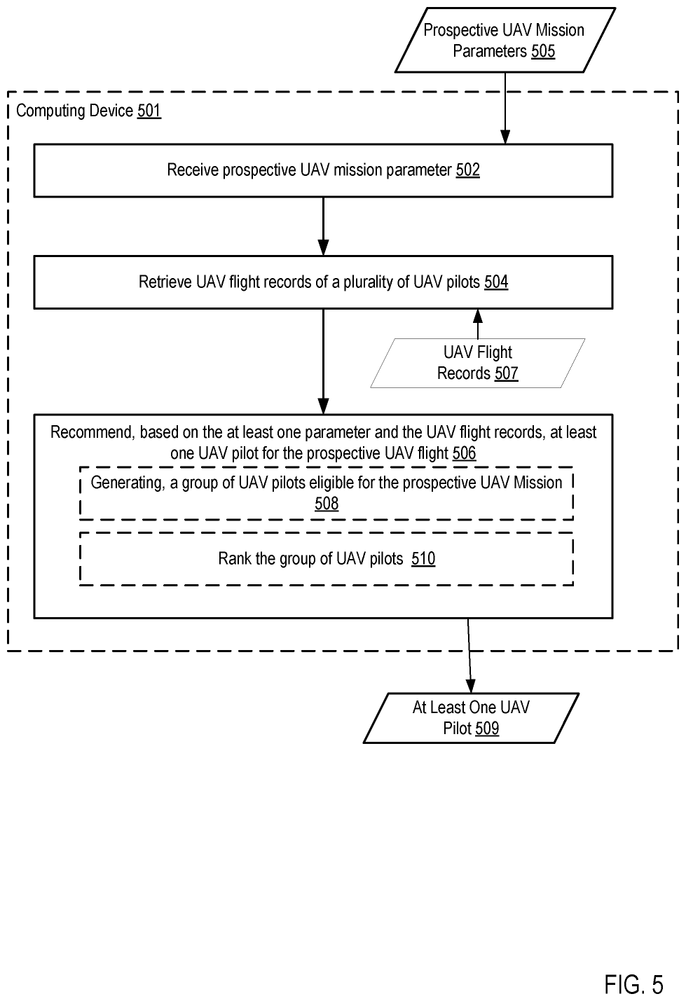

For further explanation, FIG. 5 sets forth a flow chart illustrating an exemplary method for unmanned aerial vehicle pilot recommendation in accordance with at least one embodiment of the present disclosure. The method of FIG. 5 includes a computing device (501) of a UAV recommendation ecosystem receiving (502) at least one prospective UAV mission parameter (505). The computing device (501) may be, for example, the server (140) of FIGS. 1s and 4. The prospective UAV mission parameter (505) may include parameters such as such as UAV pilot flight hours, UAV flight hours, geographic experience, UAV pilot rating, UAV rating, UAV mission type, UAV experience rating, UAV type, trust rating, cumulative UAV missions, UAV type, or UAV add-ons. Receiving (502), by the computing device (501), the prospective UAV mission parameters (505) may be carried out by the computing device (501) providing an API for receiving, from another device (e.g., the user device (440) of FIG. 4) and by the other device providing the prospective UAV mission parameters (505) using the API. Receiving (502), by the computing device (501), the prospective UAV mission parameters (505) may also be carried out by a device providing a graphical user interface (GUI) to a user that inputs the prospective UAV mission parameters (505) via the GUI, and by the computing device (501) receiving the prospective UAV mission parameters (505).

The method of FIG. 5 also includes retrieving (504), by the computing device (501), one or more UAV flight records (507). Retrieving (504), by the computing device (501), one or more UAV flight records (507) may be carried out by the computing device (501). As explained above, the one or more UAV flight records data may be stored in various devices in the UAV ecosystem in a variety of formats, including within a blockchain data structure. The computing device (501) may access this data by requesting and receiving the data from one or more devices in the UAV ecosystem including but not limited to a UAV (e.g., the UAV (102) of FIG. 1); computers (e.g., the computers (158) of FIG. 1) of a distributed computing network (e.g., the distributed computing network (151) of FIG. 1); a server (e.g., the server (140) of FIG. 1); and a control device (e.g., the control device (120) of FIG. 1). In another example, the computing device (501) is a device that has direct access to the data that indicates the one or more parameters associated with the UAV. For example, the server may be a computer that stores a database of UAV types and their parameters, or a computer that stores a copy of the blockchain data structure associated with a UAV of the type of UAV that includes the UAV parameters.

The method of FIG. 5 also includes recommending (506), by the computing device (501) based on the prospective UAV mission parameters (505) and the UAV flight records, at least one UAV pilot for the prospective UAV mission. Recommending (506), by the computing device (501) based on the prospective UAV mission parameters (505) and the UAV flight records, at least one UAV pilot for the prospective UAV flight may be carried out by the computing device (501) comparing prospective UAV mission parameters (505) to the UAV flight records to determine a UAV pilot that is suitable for the prospective UAV mission. For example, the computing device (501) may examine the UAV flight records (507) to determine a UAV pilot that has a UAV mission history that is suitable for the prospective UAV mission based on the prospective UAV mission parameters (505). In some examples, recommending (506) may further comprise generating (508) a group of UAV pilots eligible for the prospective UAV mission. For example, the computing device (501) may find multiple UAV pilots during the examination of the UAV flight records (507). Rather than recommending a single UAV pilot, the computing device (501) may recommend a group of UAV pilots. In another example, the computing device (501) may further rank (510) the group of UAV pilots. The ranking may be based on the received prospective UAV mission parameters (505). For example, some prospective UAV mission parameters (505) may be desired but, not necessarily required. UAV pilots matching more of the desired UAV mission parameters (470) may be ranked higher than those that do not match the desired UAV mission parameters (470).

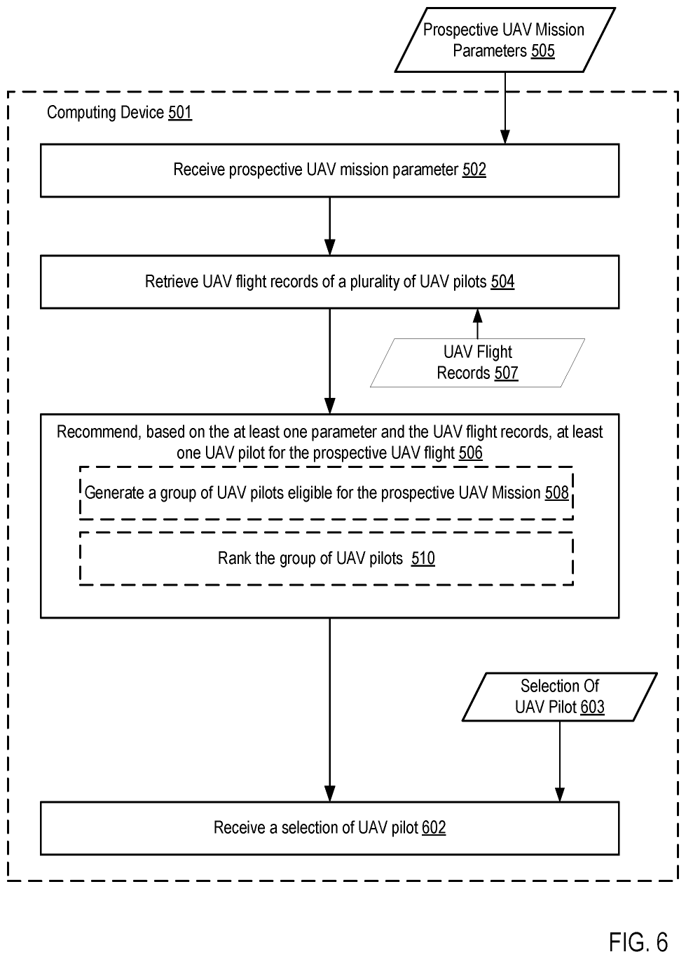

For further explanation, FIG. 6 sets forth a flow chart illustrating an exemplary method for unmanned aerial vehicle UAV pilot recommendation in accordance with at least one embodiment of the present disclosure. Like the exemplary method of FIG. 5, the exemplary method of FIG. 6 also includes receiving (502), by the computing device, at least one prospective UAV mission parameter (505); retrieving (504), by the computing device, one or more UAV flight records (507); and recommending (506) by the computing device (501), at least one UAV pilot (509).

The exemplary method of FIG. 6 differs from the method of FIG. 5 in that the method of FIG. 6 further comprises receiving (602), by the computing device, a selection of a UAV pilot (603) from the group of UAV pilots. Receiving (602), by the computing device (501), a selection of a UAV pilot (603) may be carried out by the computing device (501) providing an API for receiving, from another device (e.g., the user device (440) of FIG. 4) and by the other device providing the selection of the UAV pilot using the API. Receiving (602), by the computing device (501), the selection of the UAV pilot (603) may also be carried out by a device providing a graphical user interface (GUI) to a user that selects the UAV pilot via the GUI, and by the computing device (501) receiving the selection of the UAV pilot (603).

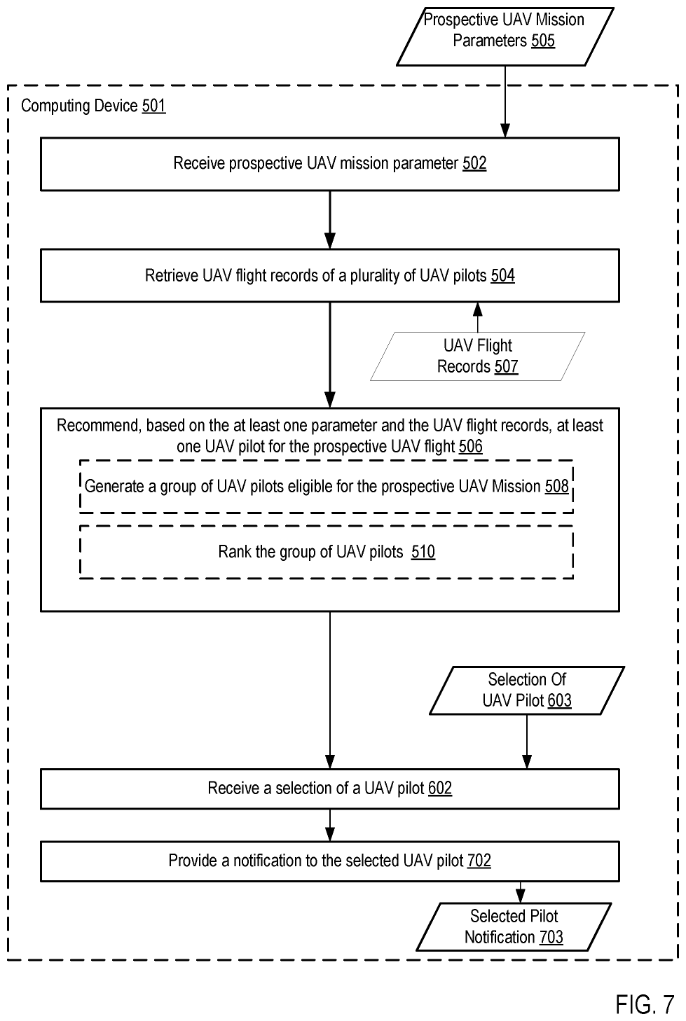

For further explanation, FIG. 7 sets forth a flow chart illustrating an exemplary method for unmanned aerial vehicle UAV pilot recommendation in accordance with at least one embodiment of the present disclosure. Like the exemplary method of FIG. 6, the exemplary method of FIG. 7 also includes receiving (502), by the computing device, at least one prospective UAV mission parameter (505); retrieving (504), by the computing device, one or more UAV flight records (507); recommending (506) by the computing device (501), at least one UAV pilot (509); and receiving (602), by the computing device, a selection of UAV pilot.

The exemplary method of FIG. 7 differs from the method of FIG. 6 in that the method of FIG. 7 further comprises providing (702), by the computing device (501), a notification to the selected UAV pilot (703). Providing (702) a notification to the selected UAV pilot (703) may be carried out by sending a network message to a device, such as UAV pilot management device (460) of FIG. 4.

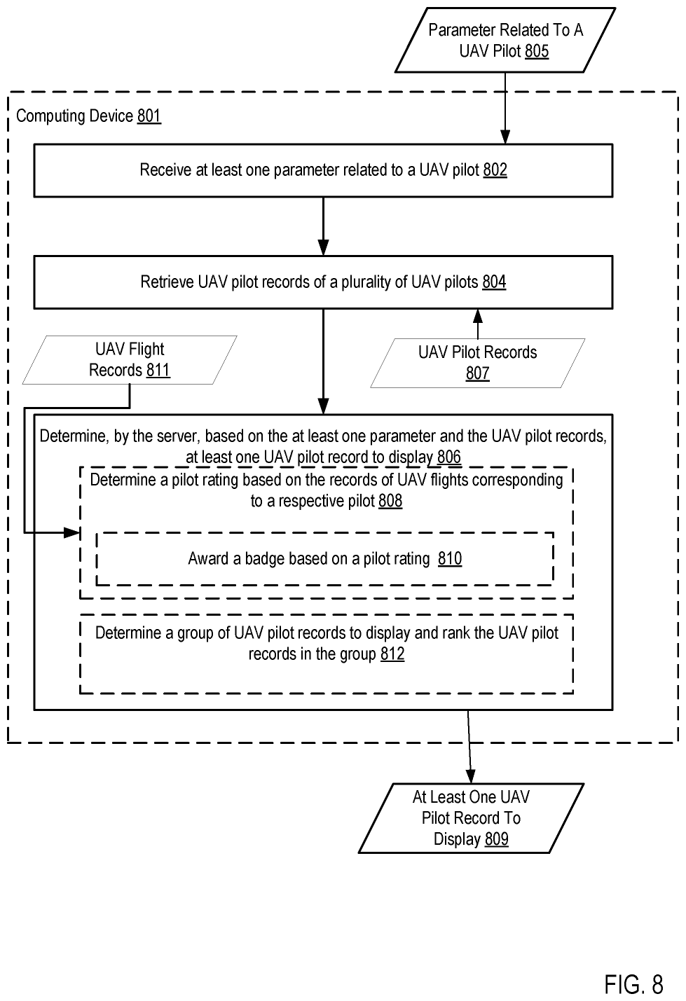

For further explanation, FIG. 8 sets forth a flow chart illustrating an exemplary method for unmanned aerial vehicle (UAV) pilot records recommendation in accordance with at least one embodiment of the present disclosure. The exemplary method of FIG. 8 includes a computing device (801) of a UAV recommendation ecosystem. The computing device (801) may be, for example, the server (140) of FIGS. 1 and 4. The method of FIG. 8 includes the computing device receiving (802) at least one UAV pilot parameter (805). The at least one UAV pilot parameter (805) may include parameters such as a UAV pilot name, a UAV pilot identification, a UAV pilot location, a UAV type, a UAV name, a UAV model, a UAV location, a UAV pilot rating, or a UAV pilot experience rating. Receiving (802), by the computing device (801), the at least one UAV pilot parameter (805) may be carried out by the computing device (801) providing an API for receiving, from another device (e.g., the user device (440) of FIG. 4) and by the other device providing the at least one UAV pilot parameter (805) using the API. Receiving (802), by the computing device (801), the at least UAV pilot parameter (805) may also be carried out by a device providing a graphical user interface (GUI) to a user that inputs the at least one UAV pilot parameter (805) via the GUI, and by the computing device (801) receiving the at least one UAV pilot parameter (805).

The method of FIG. 8 also includes retrieving (804), by the computing device (801), UAV pilot records (807). Retrieving (804), by the computing device (801), UAV pilot records (807) may be carried out by the computing device (801). As explained above, the UAV pilot records (807) may be stored in various devices in the UAV ecosystem in a variety of formats, including within a blockchain data structure. The computing device (801) may access this data by requesting and receiving the data from one or more devices in the UAV ecosystem including but not limited to a UAV (e.g., the UAV (102) of FIG. 1); computers (e.g., the computers (158) of FIG. 1) of a distributed computing network (e.g., the distributed computing network (151) of FIG. 1); a server (e.g., the server (140) of FIG. 1); and a control device (e.g., the control device (120) of FIG. 1). In another example, the computing device (801) is a device that has direct access to the data that indicates the one or more parameters associated with the UAV. For example, the computing device may be a computer that stores a database of UAV types and their parameters, or a computer that stores a copy of the blockchain data structure associated with a UAV of the type of UAV that includes the UAV parameters.

The method of FIG. 8 also includes determining (806), by the computing device (801) based on the UAV pilot parameter (805) and the UAV pilot records (807), at least one UAV pilot record (809) to display. Determining (806), by the computing device (801) based on the UAV pilot parameter (805) and the UAV pilot records (807), at least one UAV record to display (809) may be carried out by the computing device (801) comparing the parameter related to a UAV pilot to the records of the UAV pilot records to determine a record that matches the UAV pilot parameter (805). For example, the computing device (801) may examine the UAV pilot records (807) to determine a UAV pilot record that matches the parameter related to a UAV pilot record. In some examples, determining (806) at least one UAV pilot record may further comprise determining (808) a UAV pilot experience rating based on the UAV flight records (811) corresponding to a respective UAV pilot. For example, the computing device (801) may use the UAV flight records (822) for a UAV pilot to compute a UAV pilot experience rating for a respective UAV pilot as described previously with regard to FIG. 4. In another example, the computing device (801) may further award (810) a badge based on a UAV pilot experience rating. The badge may be based on the computed UAV pilot experience rating or some other criteria as described previously with respect to FIG. 4.

In another example, the computing device may determine (812) a group of UAV pilot records to display and rank the UAV pilot records in the group. For example, the computing device may determine that multiple record match the parameter related to a UAV pilot. The computing device may determine to display all of the matching UAV pilot records and rank them. For example, the UAV pilot records can be ranked by UAV pilot experience rating or by total number of badges.

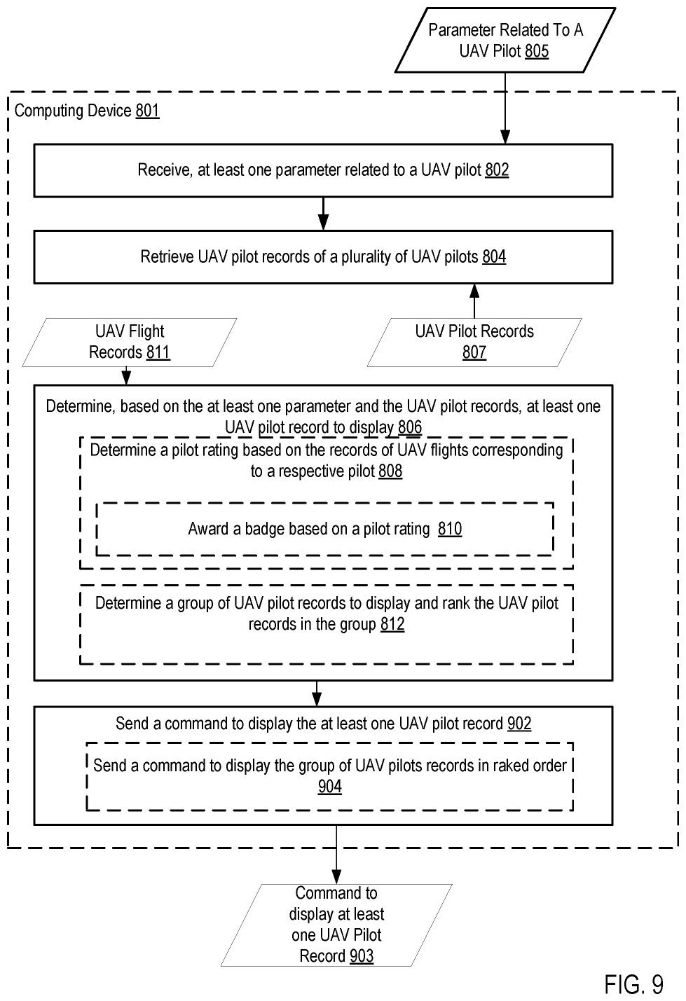

For further explanation, FIG. 9 sets forth a flow chart illustrating an exemplary method for unmanned aerial vehicle (UAV) pilot records recommendation in accordance with at least one embodiment of the present disclosure. Like the exemplary method of FIG. 8, the exemplary method of FIG. 9 also includes receiving (802), by a computing device in a UAV ecosystem, UAV pilot parameter (805); retrieving (804), by the computing device (801), UAV pilot records (807); determining (806), by the computing device (801), based on the at least one UAV pilot parameter (805) and the UAV pilot records (807) at least one UAV pilot record to display.

The exemplary method of FIG. 9 differs from the method of FIG. 8 in that the method further includes sending (902), by the computing device, a command (903) to display the at least one UAV pilot record. For example, the computing device (801) may send a command to the device that originated the original parameter related to a UAV pilot, such as user device (440) of FIG. 4 or UAV pilot management device (460) of FIG. 4. In another example, the computing device (801) may send (904) a command (903) to display the group of UAV pilot records in a ranked order. For example, the command may be received by a user device and the user device may then display the group of UAV pilot records in a ranked order. The ranked order may be at least partially based on any badges awarded to the UAV pilots. For example, a UAV pilot with more badges can be ranked higher than a UAV pilot with few badges.

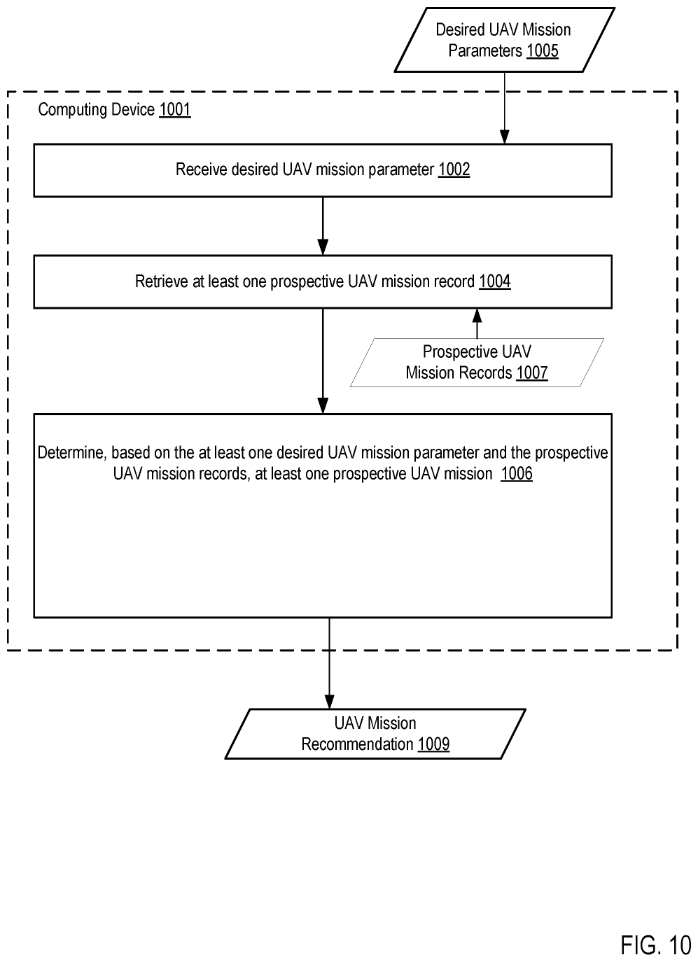

For further explanation, FIG. 10 sets forth a flow chart illustrating an exemplary method for unmanned aerial vehicle mission recommendation in accordance with at least one embodiment of the present disclosure. The method of FIG. 10 includes a computing device (1001) of a UAV recommendation ecosystem receiving (1002) at least one desired UAV mission parameter (1005). The computing device (1001) may be, for example, the server (140) of FIG. 1. The desired UAV mission parameter (1005) may include parameters such as such UAV pilot flight hours, UAV flight hours, geographic experience, UAV pilot rating, UAV rating, UAV mission type, UAV pilot experience rating, UAV type, trust rating, cumulative UAV missions, UAV type, or UAV addons. Receiving (1002), by the computing device (1001), the desired UAV mission parameters (1005) may be carried out by the computing device (1001) providing an API for receiving, from another device (e.g., the UAV pilot management device (460) of FIG. 4) and by the other device providing the desired UAV mission parameters (1005) using the API. Receiving (1002), by the computing device (1001), the desired UAV mission parameters (1005) may also be carried out by a device providing a graphical user interface (GUI) to a user that inputs the desired UAV mission parameters (1005) via the GUI, and by the computing device (1001) receiving the desired UAV mission parameters (1005).

The method of FIG. 10 also includes retrieving (1004), by the computing device (1001), at least one prospective UAV mission record from a repository of prospective UAV mission records (1007). Retrieving (1004), by the computing device (1001), prospective UAV mission records (1007) may be carried out by the computing device (1001). As explained above, the one or more prospective UAV mission records (1007) may be stored in various devices in the UAV ecosystem in a variety of formats. The computing device (1001) may access this data by requesting and receiving the data from one or more devices in the UAV ecosystem including but not limited to computers (e.g., the computers (158) of FIG. 1) of a distributed computing network (e.g., the distributed computing network (151) of FIG. 1); a server (e.g., the server (140) of FIG. 1); and a control device (e.g., the control device (120) of FIG. 1).

The method of FIG. 10 also includes determining (1006), by the computing device (1001) based on the desired UAV mission parameters (1005) and the prospective UAV mission records (1007), at least one prospective UAV mission (1009). Determining (1006), by the computing device (1001) based on the desired UAV mission parameters (1005) and the prospective UAV mission records (1007), at least one prospective UAV mission (1009) may be carried out by the computing device (1001) comparing desired UAV mission parameters (1005) to the prospective UAV mission records to determine a UAV mission that is suitable. For example, the computing device (1001) may examine the prospective UAV mission records (1007) to determine a UAV mission that aligns with desired UAV mission parameters (1005). In some examples, the prospective UAV mission data can include at least one of UAV pilot flight hours, UAV flight hours, geographic experience, UAV pilot rating, UAV rating, UAV mission type, UAV pilot experience rating, UAV type, trust rating, cumulative UAV missions, UAV type, or UAV addons. In some examples, the desired UAV mission parameters (1005) include at least one of UAV pilot desired mission type, UAV rate, and availability.

Exemplary embodiments of the present invention are described largely in the context of a fully functional computer system for utilizing an unmanned aerial vehicle for emergency response. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method for unmanned aerial vehicle (UAV) pilot recommendation, the method comprising: receiving, by a computing system, at least one parameter related to a prospective UAV mission; retrieving, by the computing system, UAV flight records of a plurality of UAV pilots; and recommending, by the computing system, based on the at least one parameter and the UAV flight records, at least one UAV pilot for the prospective UAV mission.

2. The method of statement 1, wherein the at least one parameter comprises at least one of UAV pilot flight hours, UAV flight hours, geographic experience, UAV pilot rating, UAV rating, UAV mission type, UAV pilot experience rating, UAV type, trust rating, cumulative UAV missions, UAV type, and UAV addons.

3. The method of any of the statements 1-2, wherein the prospective UAV mission comprises at least one of an inspection, a mapping mission, a delivery mission, a video mission, and a photography mission.

4. The method of any of the statements 1-3, wherein the UAV flight records comprise at least one record including UAV pilot flight hours, UAV flight hours, geographic experience, UAV pilot rating, UAV rating, UAV mission type, experience rating, cumulative UAV missions, UAV type, or UAV addons.

5. The method of any of the statements 1-4, wherein recommending based on the at least one parameter and the UAV flight records, at least one UAV pilot for the prospective UAV mission comprises generating a group of UAV pilots eligible for the prospective UAV mission.

6. The method of any of the statements 1-5, wherein recommending based on the at least one parameter and the UAV flight records at least one UAV pilot for the prospective UAV mission comprises ranking, based on the at least one parameter related to the prospective UAV mission, the group of UAV pilots.

7. The method of any of the statements 1-6, further comprising receiving, by a computing system, a selection of a UAV pilot from the group of UAV pilots to fly the prospective UAV mission.

8. The method of any of the statements 1-7, further comprising notifying, by a computing system, the UAV pilot of the selection of the UAV pilot.

9. A method of unmanned aerial vehicle (UAV) pilot records recommendation and also any of the statements 1-8, the method comprising: receiving, by a computing system, at least one parameter related to a UAV pilot; retrieving, by the computing system, UAV pilot records of a plurality of UAV pilots; and determining, based on the at least one parameter and the UAV pilot records, by the computing system, at least one record related to at least one UAV pilot to display.

10. The method of any of the statements 1-9, wherein the at least one parameter includes at least one of a UAV pilot name, a UAV pilot identification, a UAV pilot location, a UAV type, a UAV name, a UAV model, a UAV location, a UAV pilot rating, or a UAV pilot experience rating.

11. The method of any of the statements 1-10, wherein determining at least one record related to at least one UAV pilot to display further comprises determining, by the computing system, a UAV pilot experience rating based on UAV flight records corresponding to a respective UAV pilot.

12. The method of any of the statements 1-11, wherein determining, by the computing system, at least one record related to at least one UAV pilot to display further comprises determining a group of UAV pilot records to display and ranking the UAV pilot records.

13. The method of any of the statements 1-12, wherein determining a UAV pilot experience rating further comprises awarding a badge to a respective UAV pilot.

14. The method of any of the statements 1-13, wherein the badge is awarded based on at least one of UAV pilot hours, UAV hours, quantity of UAV missions, UAV mission type, UAV mission location, and UAV pilot experience rating.

15. The method of any of the statements 1-14, further comprising: sending a command to display a record of the at least one UAV pilot and at least one badge awarded to the at least one UAV pilot.

16. The method of any of the statements 1-15, further comprising sending a command to display the group of UAV pilot records in a ranked order.

17. The method of any of the statements 1-16, wherein the ranked order of the UAV pilot records is based at least partially on a badge awarded to the at least one UAV pilot.

18. A method of unmanned aerial vehicle (UAV) mission recommendation and also any of the statements 1-17, the method comprising: receiving, by a computing device, at least one parameter related to a desired UAV mission; retrieving, by the computing device, at least one prospective UAV mission record from a repository of prospective UAV mission records; and determining, based on the at least one parameter and the at least one prospective UAV mission record, by the computing system, at least one prospective UAV mission to recommend for a UAV pilot.

19. The method of any of the statements 1-18, wherein the prospective UAV mission records includes at least one of UAV pilot flight hours, UAV flight hours, geographic experience, UAV pilot rating, UAV rating, UAV mission type, UAV pilot experience rating, UAV type, trust rating, cumulative UAV missions, UAV type, or UAV addons.

20. The method of any of the statements 1-19, wherein the at least one parameter related to a desired UAV mission includes at least one of UAV pilot desired mission type, UAV rate, and availability.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for unmanned aerial vehicle (UAV) pilot recommendation, the method comprising:
receiving, by a computing system, at least one parameter related to a prospective UAV mission;
retrieving, by the computing system, UAV flight records of a plurality of UAV pilots; and
recommending, by the computing system, based on the at least one parameter and the UAV flight records, at least one UAV pilot for the prospective UAV mission.

2. The method of claim 1, wherein the at least one parameter comprises at least one of UAV pilot flight hours, UAV flight hours, geographic experience, UAV pilot rating, UAV rating, UAV mission type, UAV pilot experience rating, UAV type, trust rating, cumulative UAV missions, UAV type, and UAV addons.

3. The method of claim 1, wherein the prospective UAV mission comprises at least one of an inspection, a mapping mission, a delivery mission, a video mission, and a photography mission.

4. The method of claim 1, wherein the UAV flight records comprise at least one record including UAV pilot flight hours, UAV flight hours, geographic experience, UAV pilot rating, UAV rating, UAV mission type, experience rating, cumulative UAV missions, UAV type, or UAV addons.

5. The method of claim 1, wherein recommending based on the at least one parameter and the UAV flight records, at least one UAV pilot for the prospective UAV mission comprises generating a group of UAV pilots eligible for the prospective UAV mission.

6. The method of claim 5, wherein recommending based on the at least one parameter and the UAV flight records at least one UAV pilot for the prospective UAV mission comprises ranking, based on the at least one parameter related to the prospective UAV mission, the group of UAV pilots.

7. The method of claim 5, further comprising receiving, by a computing system, a selection of a UAV pilot from the group of UAV pilots to fly the prospective UAV mission.

8. The method of claim 7, further comprising notifying, by a computing system, the UAV pilot of the selection of the UAV pilot.

9. A method of unmanned aerial vehicle (UAV) pilot records recommendation, the method comprising:
receiving, by a computing system, at least one parameter related to a UAV pilot;
retrieving, by the computing system, UAV pilot records of a plurality of UAV pilots; and
determining, based on the at least one parameter and the UAV pilot records, by the computing system, at least one record related to at least one UAV pilot to display.

10. The method of claim 9, wherein the at least one parameter includes at least one of a UAV pilot name, a UAV pilot identification, a UAV pilot location, a UAV type, a UAV name, a UAV model, a UAV location, a UAV pilot rating, or a UAV pilot experience rating.

11. The method of claim 9, wherein determining at least one record related to at least one UAV pilot to display further comprises determining, by the computing system, a UAV pilot experience rating based on UAV flight records corresponding to a respective UAV pilot.

12. The method of claim 9, wherein determining, by the computing system, at least one record related to at least one UAV pilot to display further comprises determining a group of UAV pilot records to display and ranking the UAV pilot records.

13. The method of claim 11, wherein determining a UAV pilot experience rating further comprises awarding a badge to a respective UAV pilot.

14. The method of claim 13, wherein the badge is awarded based on at least one of UAV pilot hours, UAV hours, quantity of UAV missions, UAV mission type, UAV mission location, and UAV pilot experience rating.

15. The method of claim 14, further comprising: sending a command to display a record of the at least one UAV pilot and at least one badge awarded to the at least one UAV pilot.

16. The method of claim 12, further comprising sending a command to display the group of UAV pilot records in a ranked order.

17. The method of claim 16, wherein the ranked order of the UAV pilot records is based at least partially on a badge awarded to the at least one UAV pilot.

18. A method of unmanned aerial vehicle (UAV) mission recommendation, the method comprising:
receiving, by a computing device, at least one parameter related to a desired UAV mission;
retrieving, by the computing device, at least one prospective UAV mission record from a repository of prospective UAV mission records; and
determining, based on the at least one parameter and the at least one prospective UAV mission record, by the computing system, at least one prospective UAV mission to recommend for a UAV pilot.

19. The method of claim 18, wherein the prospective UAV mission records includes at least one of UAV pilot flight hours, UAV flight hours, geographic experience, UAV pilot rating, UAV rating, UAV mission type, UAV pilot experience rating, UAV type, trust rating, cumulative UAV missions, UAV type, or UAV addons.

20. The method of claim 18, wherein the at least one parameter related to a desired UAV mission includes at least one of UAV pilot desired mission type, UAV rate, and availability.
